(19) United States
(12) Patent Application Publication
(10) Pub. No.: US 2013/0067332 A1
(43) Pub. Date: Mar. 14, 2013

(54) MEDIA SEEK BAR

(71) Applicants: Michael Greenwood, Redmond, WA (US); Joe Chauvin, Sammamish, WA (US); Ramrajprabu Balasubramanian, Renton, WA (US)

(72) Inventors: Michael Greenwood, Redmond, WA (US); Joe Chauvin, Sammamish, WA (US); Ramrajprabu Balasubramanian, Renton, WA (US)

(73) Assignee: MICROSOFT CORPORATION, Redmond, WA (US)

(21) Appl. No.: 13/230,461

(22) Filed: Sep. 12, 2011

(51) Int. Cl. G06F 3/00

(52) U.S. Cl. 715/720; 715/716

(57) ABSTRACT

A graphical user interface is output for presentation by a graphical display device. The graphical user interface includes visual aspects of a time-based media content item having a playback axis, and a seek bar having a position along the playback axis. The position of the seek bar along the playback axis indicates a current playback position of the time-based media content item. The seek bar extends perpendicular to the playback axis over the visual aspects of the time-based media content item. A drag command representing a user input directed at the seek bar is received. The drag command is characterized by a drag path. The current playback position of the time-based media content item is moved based on the drag path.

### BACKGROUND

Media players provide users with control over time-based media content that includes audio and/or video. Common media player control functions include play, pause, forward seek, reverse seek, skip forward, skip back, etc. These control functions may take the form of a linear progress bar typically located above or below a top or bottom edge of a media presentation window. A slider traveling along the linear progress bar provides a visual indication of the playback position of the media, and enables a user to change the playback position by translating the slider in either direction along the linear progress bar.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Embodiments relating to a media seek bar are disclosed. As one example, a graphical user interface is provided that includes visual aspects of a time-based media content item having a playback axis, and a seek bar having a position along the playback axis that indicates a current playback position of the time-based media content item. The seek bar extends perpendicular to the playback axis over the visual aspects of the time-based media content item. A drag command representing a user input directed at the seek bar may be received. The drag command is characterized by a drag path. The current playback position of the time-based media content item may be moved based on the drag path.

### BRIEF DESCRIPTION OF THE DRAWINGS

FIG. 1 shows an example graphical user interface including a seek bar located at a first position according to one disclosed embodiment.

FIG. 2 shows the example graphical user interface of FIG. 1 including the seek bar located at a second position.

FIG. 3 shows an example graphical user interface including a seek bar that is movable in forward and reverse directions according to one disclosed embodiment.

FIG. 4 shows an example graphical user interface depicting a variety of drag paths of a seek bar according to one disclosed embodiment.

FIG. 5 shows the example graphical user interface of FIG. 4 operatively divided into a plurality of scaling factor regions according to one disclosed embodiment.

FIG. 6 shows an example graphical user interface including a variety of graphical indicators associated with a seek bar according to one disclosed embodiment.

FIG. 7 shows an example graphical user interface including a seek bar that extends beyond a presentation region containing visual aspects of a time-based media content item according to one disclosed embodiment.

FIG. 8 shows an example graphical user interface including a seek bar and transport control buttons according to one disclosed embodiment.

FIG. 9 shows a graphical user interface including a variety of graphical indicators associated with a seek bar according to one disclosed embodiment.

FIG. 10 shows a flow diagram depicting an example method of presenting time-based media content items with a computing device according to one disclosed embodiment.

FIG. 11 shows a table depicting example scaling factors according to one disclosed embodiment.

FIG. 12 is a schematic diagram depicting an example computing system according to one disclosed embodiment.

### DETAILED DESCRIPTION

The seek bar disclosed herein enables a user to change the current playback position of a time-based media content item (e.g., a movie or song). The user advances the playback position by moving the seek bar in a first direction (e.g., right) and rewinds the playback position by moving the seek bar in the opposite direction (e.g., left). Such movement is along a playback axis of the time-based media content item. The user may optionally scale how fast the playback position advances or rewinds with input that is perpendicular to this playback axis. For example, by touching the seek bar and dragging up and to the right, the playback position may advance with finer precision than if the user drags to the right without any upward or downward movement. These and other aspects of the disclosed seek bar are described below.

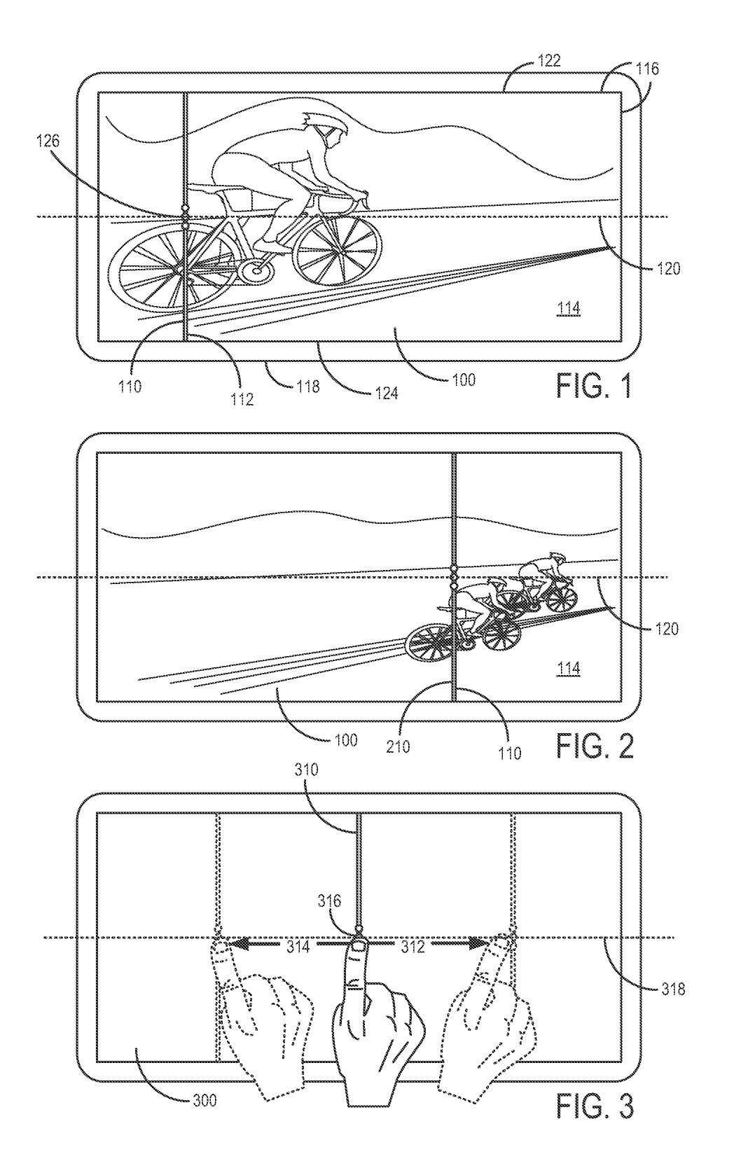

FIG. 1 shows an example graphical user interface (GUI) 100 including a seek bar 110 located at a first position 112. GUI 100 further includes visual aspects 114 of a time-based media content item displayed within a presentation window 116. In this particular example, presentation window 116 occupies the entirety of GUI 100, which may correspond to a full screen viewing mode. However, presentation window 116 may occupy only a portion of a GUI or available display surface. GUI 100 may be presented via a graphical display device 118.

The time-based media content item may include, for example, video content and/or audio content. The time-based media content item may have a playback axis 120, which may be invisible to the user. First position 112 of seek bar 110 along playback axis 120 indicates a current playback position of the time-based media content item. For example, a position to the far left of GUI 100 may correspond to the beginning of the time-based media content item and a position to the far right of GUI 100 may correspond to the end of the time-based media content item. As the time-based media content item progresses from beginning to end, the position of the seek bar 110, when visible, may proportionally move across the GUI 100 along playback axis 120.

Seek bar 110 extends perpendicular to playback axis 120 over visual aspects 114 of the time-based media content item. As one example, seek bar 110 may have a vertical orientation relative to a display orientation of visual aspects 114. In the illustrated embodiment, seek bar 110 extends from a first edge 122 to an opposing second edge 124 of the presentation window 116. By extending all the way across the presentation window, the seek bar may provide greater visual feedback to the user and/or may provide a larger target toward which a user may direct a user input. Furthermore, if the presentation window is set to occupy the entire graphical user interface, such as, for example, during a full-screen viewing mode, then the entire graphical user interface is made available to the user to provide a drag path for controlling playback of the media content.

Visual aspects 114 may vary with the type of time-based media content item that is presented. As one example, visual aspects of a video content item may include the video component of the video content (e.g., the video images). Such a video content item may further include an audio component to be presented via an audio speaker. As another example, visual aspects of an audio content item may include a static image (e.g., an album cover or other suitable image accompanying the audio content item as meta-data) or a dynamic visualization generated from the audio content.

Seek bar 110 may optionally include a selector 126. In the illustrated embodiment, selector 126 is located at a centerline position of seek bar 110 between first edge 122 and second edge 124. Users may direct input to selector 126 in order to move seek bar 110. In other embodiments, a selector may be positioned above or below a centerline, or the entire seek bar may serve as the selector.

As explained by way of example below, a drag command characterized by a drag path can be directed to selector 126, seek bar 110, and/or related aspects of GUI 100. The drag path may be multidimensional (e.g., two-dimensional), and a distance of the drag path along each dimension may, in combination, define the amount that a current playback position of the time-based content item is moved. A first dimension of the drag path that is parallel to a playback axis of the time-based media content item may define a relative amount that the current playback position is to be moved. A second dimension of the drag path perpendicular to the playback axis may define a scaling factor that is applied to the relative amount measured along the first dimension to obtain an absolute amount that the current playback position is moved.

FIG. 2 shows example GUI 100 of FIG. 1 including seek bar 110 located at a second position 210. Second position 210 of seek bar 110 along playback axis 120 indicates a different playback position of the time-based media content item of FIG. 1. For example, for a video content item, visual aspects 114 depicted in FIG. 2 may correspond to a later playback position than visual aspects 114 of FIG. 1 as indicated by second position 210 relative to first position 112. Accordingly, time proceeds in a forward direction from left to right in this particular example. However, in other examples, time may instead proceed in a forward direction from right to left along playback axis 120. In still other examples, a time-based content item may have a vertical playback axis, in which case a seek bar may extend horizontally over visual aspects of the content item.

FIG. 3 shows an example GUI 300 including a seek bar 310 that is movable in forward and reverse directions. User inputs are represented by drag commands directed at seek bar 310. The drag commands are characterized by drag paths 312 and 314. The user inputs of FIG. 3 are depicted as being received as touch-based inputs via a touch-sensitive graphical display. However, in other examples, user inputs may be received via other suitable user input devices, such as a controller, mouse, trackpad, keyboard, optical sensor, depth camera, etc. A drag command may be performed by a user selecting seek bar 310 and translating the seek bar along a drag path while maintaining the selection.

Seek bar 310 includes selector 316 that corresponds to an initial position of drag paths 312 and 314. A user may direct user input to selector 316 in some implementations. For example, a user may select selector 316 to enable translation of seek bar 310 along a drag path. However, in other implementations, a user may direct user input to any portion of seek bar 310 to select the seek bar.

A current playback position of the time-based media content item may be moved in a forward direction if a drag path (e.g., drag path 312) has a vector component in a first coordinate direction parallel to playback axis 318. A current playback position of the time-based media content item may be moved in a reverse direction if a drag path (e.g., drag path 314) has a vector component in a second coordinate direction opposite the first coordinate direction and parallel to playback axis 318.

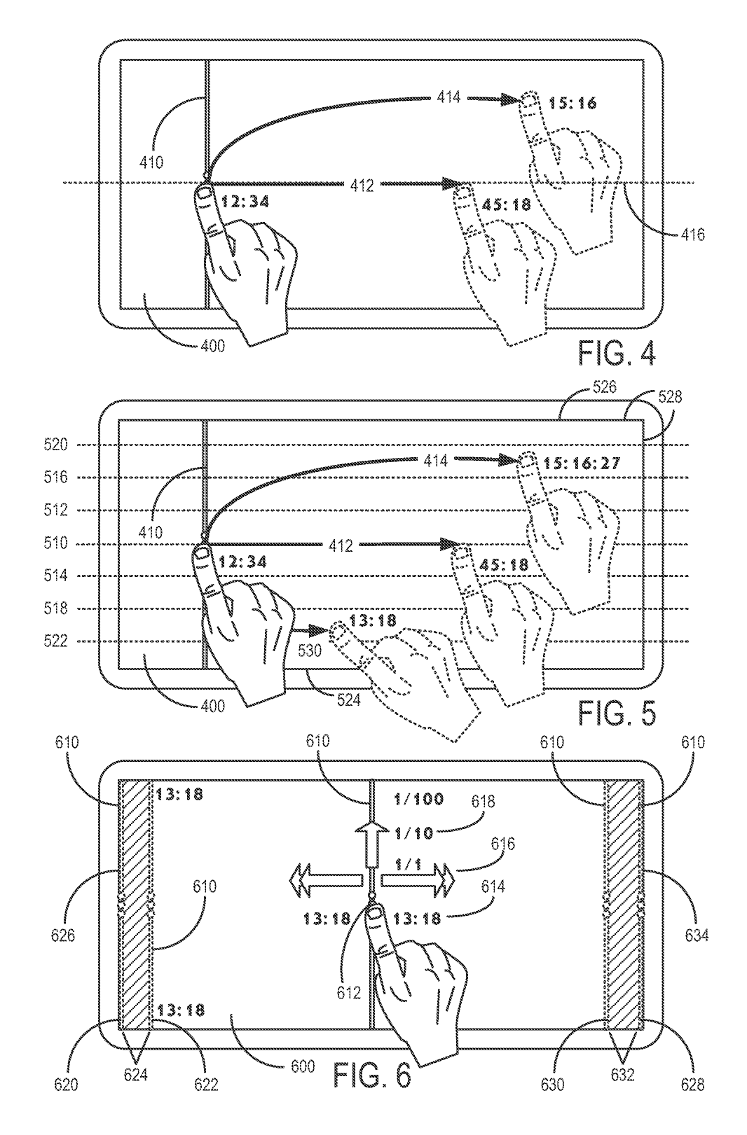

FIG. 4 shows an example GUI 400 depicting a variety of drag paths of a seek bar 410. The playback position of a time-based media content item as denoted by a corresponding time value is depicted in FIG. 4 for an initial position and a remote position of each drag path. In some implementations, the time value corresponding to the current playback position optionally may be displayed via the GUI as depicted, for example, by GUI 400.

As one example, drag path 412 may correspond to a change of the playback position of the time-based media content item from a first playback position denoted by time 12:34 to a second playback position denoted by time 45:18. By contrast, drag path 414 may correspond to a change of the playback position of the time-based media content item from the first playback position denoted by time 12:34 to a third playback position denoted by time 15:16.

A distance measured along playback axis 416 from the initial position to the remote position of drag path 414 is greater in this particular example than a distance measured along playback axis from the initial position to the remote position of drag path 412. A distance measured along an axis perpendicular to playback axis 416 from the initial position to the remote position of drag path 414 is also greater in the particular example than the distance measured along the axis perpendicular to playback axis 416 from the initial position to the remote position of drag path 412.

A scaling factor has been applied to the distance measured along playback axis 416 from the initial position to the remote position of each drag path that is based on the distance measured along the axis perpendicular to playback axis 416 between the initial position and the remote position. For the example depicted in FIG. 4, the scaling factor is decreased as the distance measured along the axis perpendicular to playback axis 416 increases. Hence, while the remote position of drag path 414 is further from the initial position than the remote position of drag path 412, the second playback position denoted by time 45:18 is further from the first playback position denoted by time 12:34 than the third playback position denoted by time 15:16 due to application of the scaling factor.

FIG. 5 shows the example GUI 400 of FIG. 4 operatively divided into a plurality of scaling factor regions according to one disclosed embodiment. These scaling factor regions may correspond to respective scaling factors applied to the distance of the drag path measured along a playback axis corresponding, for example, to centerline 510 in FIG. 5. A region bound by lines 512 and 514 surrounding centerline 510 may correspond to a first scaling factor. Regions bounded by lines 512 and 516, and by lines 514 and 518 may each correspond to a second scaling factor. Regions bounded by lines 516 and 520, and by lines 518 and 522 may correspond to a third scaling factor. Regions bounded by line 520 and a first edge 526 of presentation window 528, and by line 522 and a second edge 524 of presentation window 528 may correspond to a fourth scaling factor.

Accordingly, the scaling factor may vary (e.g., decrease or increase) by a step-wise function as the distance measured along the axis perpendicular to the playback axis increases in either direction from centerline 510 or from an initial position of the drag path. In other implementations, the scaling factor may decrease or increase by a continuous function. In some implementations, the scaling factor may vary on only one side of centerline 510 or an initial position of the drag path. In other implementations, the scaling factor may decrease on one side of centerline 510 as a distance increases from centerline 510, and may increase on another side of centerline 510 as a distance increases from centerline 510.

FIG. 5 further shows another drag path 530, which has a remote position denoted by time 13:18. Drag path 530 provides an example where the scaling factor is decreased as a distance increases from the initial position to the remote position below centerline 510.

FIG. 5 further provides an example where a time value displayed via GUI 500 (e.g., 15:16:27) may include an increased or added degree of precision (e.g., 27/60 fraction of a second) as a distance from the initial position to the remote position of the drag path (e.g., drag path 414) as measured along the axis perpendicular to the playback axis (e.g., centerline 510) increases. The increased or added degree of precision may provide additional visual feedback to the user as the scaling factor decreases to enable finer control over the current playback position of the time-based media content item.

FIG. 6 shows an example GUI 600 including a variety of graphical indicators associated with a seek bar 610 according to one disclosed embodiment. One or more of these graphical indicators may be displayed responsive to a user input directed at seek bar 610. The user input to initiate presentation of the graphical indicators may be characterized by one or more of a tap command, a select command, a select and hold command, or a drag command, for example. In some implementations, the graphical indicators may be displayed responsive only to the user input directed at a selector 612 of seek bar 610. In other implementations, the graphical indicators may be displayed responsive to a user tapping or selecting any portion of the presentation window of a media content item, or the GUI.

As one example, the graphical indicators may include text and/or numerical information 614 indicating the current playback position of the media content item. As another example, the graphical indicators may include arrows 616 or other suitable icons to indicate commands that are available to the user via manipulation of seek bar 610. As yet another example, graphical indicators may include scaling factor indicators 618 representing the scaling factor associated with different regions of GUI 600.

The graphical indicators may be displayed at one or multiple locations of GUI 600. As one example, information 614 may be displayed at or near an edge or corner of the GUI. As another example, information 614 may be displayed on one or multiple sides of seek bar 610 and/or above or below selector 612 to accommodate both right and left handed users. The size of the information 614 and the position of the information 614 relative to the seek bar may change when the seek bar is near an edge of the GUI so that the information will not go outside the boundary of the GUI.

FIG. 6 also shows seek bar 610 located at different positions along the playback axis. In some implementations, a starting position of the time-based media content item may correspond to position 620 of seek bar 610. In other implementations, a starting position of the time-based media content item may instead correspond to position 622 of seek bar 610 offset by a distance 624 from edge 626. Because seek bar 610 is offset by a distance 624 from edge 626 at position 622, a user may be able to more easily view and/or direct user input at seek bar 610. The distance 624 may be selected so as to allow touch input near the edge of a touch display, for example.

An end position of the time-based media content item may correspond to position 628 of seek bar 610. Alternatively, the end position of the time-based media content item may correspond to position 630 of seek bar 610 offset by a distance 632 from edge 634 to enable a user to more easily view and/or direct user input at seek bar 610. Distances 624 and 632 may correspond to a number of pixels of the graphical display, such as 25 or 30 pixels, for example. In other implementations, a size of the presentation window for displaying visual aspects of the time-based media content item may be reduced responsive to a user input directed at the presentation window, GUI 600, or at seek bar 610 so that the start position and/or end position of the time-based media content item may be offset from edges 626 and/or 634.

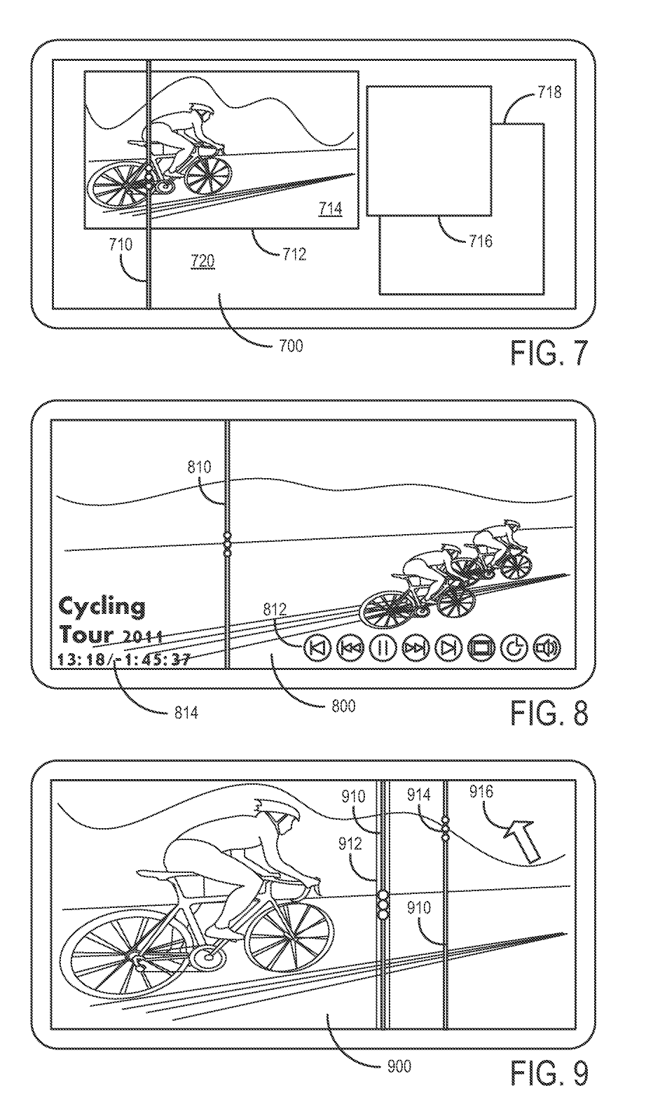

FIG. 7 shows an example GUI 700 including a seek bar 710 that extends beyond a presentation region 712 of visual aspects 714 of a time-based media content item. GUI 700 includes other windows 716 and 718 that may correspond to one or more application programs. In some implementations, seek bar 710 may extend over a desktop region 720 or a portion thereof.

FIG. 8 shows an example GUI 800 including a seek bar 810 and transport control buttons 812. Transport control buttons 812 may include one or more selectors corresponding to one or more respective functions such as play, pause, forward seek, reverse seek, start seek, end seek, full screen, menu, and volume, for example. FIG. 8 also shows GUI 800 including textual and/or numeric indicators 814 that may be descriptive of the time-based media content item and current playback position. As explained below, transport control buttons may be displayed concurrently with the seek bar, or the transport control buttons may be displayed independently while the seek bar is hidden.

FIG. 9 shows an example GUI 900 including a variety of visual indicators associated with a seek bar 910. Seek bar 910 may include a graphical indicator 912 that highlights seek bar 910 to indicate that a user input is currently directed at seek bar 910, such as responsive to a drag command or other suitable command. Such highlighting may take the form of a change in color, brightness, shape, etc. of the seek bar. FIG. 9 further depicts how selector 914 of seek bar 910 may change positions from an initial position as a drag path moves away from the initial position to a remote position along an axis perpendicular to the playback axis. A graphical indicator 916 representing a selector (e.g., an arrow or other suitable graphical indicator) may be displayed to indicate a location of the user input. Each of the examples presented in FIG. 9 may be used to provide visual feedback to the user, particularly if the user input is to be provided via a user input device other than a touch-sensitive graphical display. While a user is executing a drag command, the seek bar may track the drag path, or the seek bar may track the actual position of the time-based content relative to the content duration. If the seek bar does not track the drag path, some indication such as a visual tether, the time indicator, or the selector may follow the user input position to show that the user is providing fine control relative to the actual playback position.

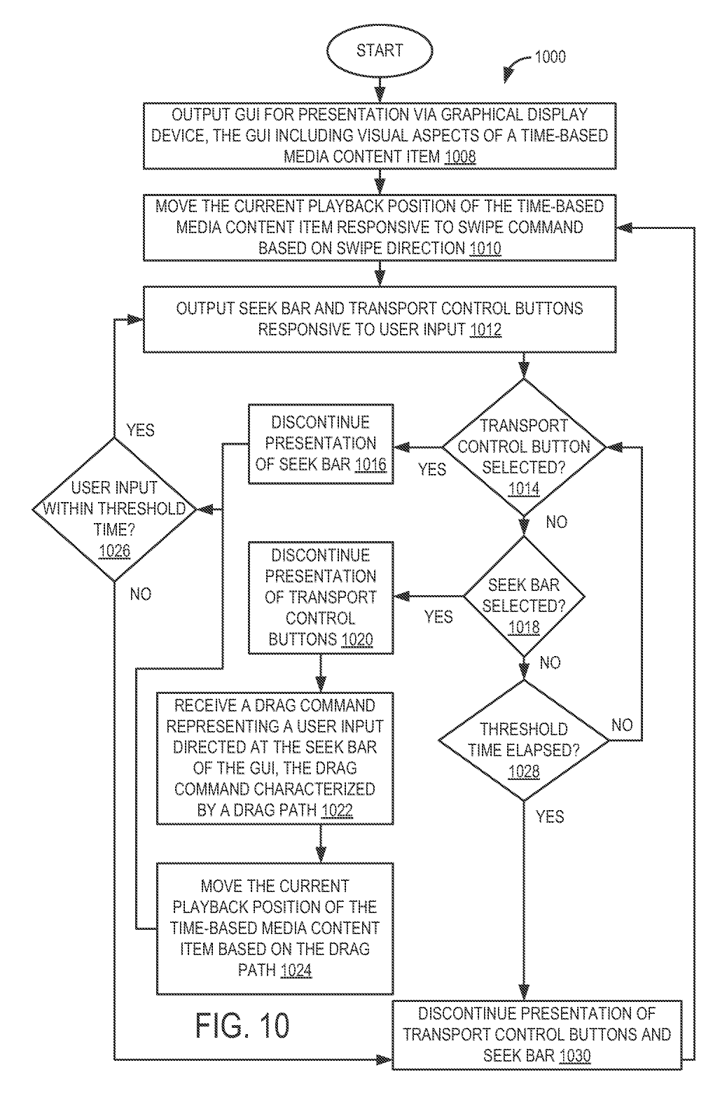

FIG. 10 shows a flow diagram depicting an example method 1000 of presenting time-based media content items with a computing device according to one disclosed embodiment. At 1008, the method may include outputting a graphical user interface for presentation via a graphical display device. The graphical user interface may include visual aspects of a time-based media content item. The visual aspects of the time-based media content item may be displayed without a seek bar or transport control buttons during some conditions, such as during a full screen mode in which a presentation window occupies the entire viewable area of the graphical display device.

At 1010, the method may include moving the current playback position of the time-based media content item responsive to a swipe command directed at the presentation window or visual aspects of the time-based media content item of the GUI. The direction that the current playback position of the time-based media content item is moved may be based on a swipe direction. For example, if a swipe direction is from left to right, then the current playback position may be moved in a forward direction. Alternatively, if the swipe direction is from right to left, then the current playback position may be moved in a reverse direction. In some implementations, the current playback position of the time-based media content item may be moved by a discrete amount (e.g., 10, 20, or 30 seconds) for each swipe command that is directed at the presentation window or visual aspects of the time-based media content item.

At 1012, the method may include outputting a GUI for presentation via a graphical display device responsive to a user input. The graphical user interface may include the visual aspects of a time-based media content item, a seek bar, and transport control buttons. The seek bar and the transport control buttons may be presented in addition to the visual aspects previously presented at 1008 responsive to a user input characterized by a tap or other command directed at the GUI, presentation window, or visual aspects of the time-based media content item. The tap or other command may be used to initiate presentation of the seek bar and/or transport control buttons in contrast to the swipe command used to move the current playback position of the time-based media content item without initiating presentation of the seek bar or transport control buttons.

As previously discussed, the seek bar may have a position along a playback axis of the time-based media content item that indicates a current playback position of the time-based media content item. The seek bar may extend perpendicular to the playback axis over the visual aspects of the time-based media content item. For example, the visual aspects of the time-based media content item may be bound by a presentation window defined by a first edge parallel to the playback axis and a second edge parallel to the playback axis. The seek bar may extend from the first edge to the second edge over the visual aspects of the time-based media content item.

If at 1014, the transport control buttons have been selected, then presentation of the seek bar may be discontinued at 1016. If at 1014, the transport control buttons have not been selected, then presentation of the seek bar may continue. If at 1018, the seek bar has been selected, then presentation of the transport control buttons may be discontinued at 1020.

At 1022, the method may include receiving a drag command representing a user input directed at the seek bar of the GUI. The drag command may be characterized by a drag path. At 1024, the method may include moving the current playback position of the time based media content item responsive to the drag command based on the drag path in two-dimensions. For example, the current playback position of the time-based media content item may be moved in a forward direction if the drag path has a vector component in a first coordinate direction parallel to the playback axis. As another example, the current playback position of the time-based media content item may be moved in a reverse direction if the drag path has a vector component in a second coordinate direction opposite the first coordinate direction and parallel to the playback axis.

The current playback position of the time-based media content item may be moved in the forward direction or in the reverse direction by an amount that is based on a distance measured along the playback axis from an initial position to a remote position of the drag path. In some implementations, the amount that the current playback position is moved in the forward or in the reverse direction may be further based on a combination of (1) a scaling factor, and (2) the distance measured along the playback axis from the initial position to the remote position of the drag path. As one example, the scaling factor may be varied based on a distance measured along an axis perpendicular to the playback axis from the initial position to the remote position of the drag path. As previously described with reference to FIGS. 4 and 5, the scaling factor may be varied, for example, by decreasing the scaling factor as the distance measured along this perpendicular axis increases.

If at 1026, user input has not been directed at the GUI or presentation window within a threshold period of time, then presentation of the transport control buttons and seek bar may be discontinued at 1030. From 1030, the process flow may return, for example, to 1008. If at 1026, user input has been directed at the GUI or presentation window within a threshold period of time, then the process flow may return, for example, to 1012.

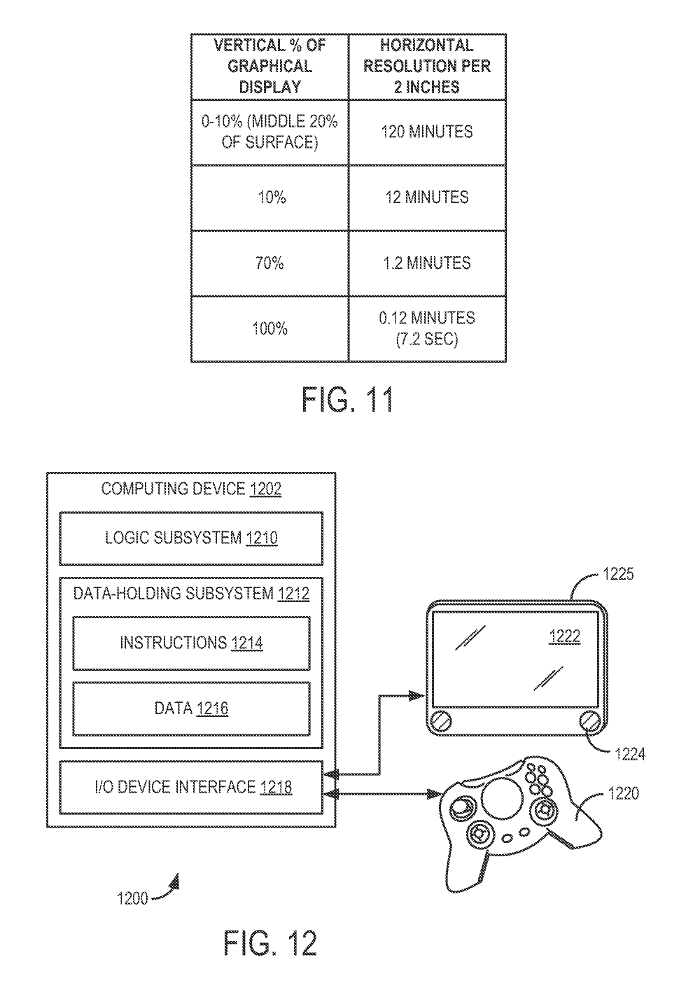

FIG. 11 shows a table depicting example scaling factors according to one disclosed embodiment. The left column presents a number of regions of a graphical display as a percentage of a graphical display as measured in a vertical direction from either side of a centerline. The right column presents a horizontal resolution of a time-based media content item for an example 2 inch graphical display. The values of FIG. 11 assume an example 2 hour (120 minute) time-based media content item such as a movie file. Based on the values of FIG. 11, a horizontal drag path within the middle 20% of the graphical display corresponds to 120 minutes per 2 inches of a drag path from an initial position to a remote position. For example, a 0.5 inch horizontal drag path within the middle 20% of the graphical display corresponds to a movement of 30 minutes of the time-based media content item. By contrast, a 0.5 inch horizontal drag path at an outer edge of the graphical display (e.g., in a full-screen viewing mode) corresponds to a movement of only 1.8 seconds (e.g., a scaling factor of 1/100th). It will be appreciated that the scaling factors of FIG. 11 are non-limiting, and that other suitable scaling factors may be used.

In some embodiments, the above described methods and processes may be tied to a computing system. In particular, the methods and processes described herein may be implemented as a computer application, computer service, computer API, computer library, and/or other computer program. For example, these methods and processes may be implemented as a media player application for a computing device.

FIG. 12 schematically shows a nonlimiting computing system 1200 that may perform one or more of the above described methods and processes. Computing system 1200 is shown in simplified form. It is to be understood that virtually any computer architecture may be used without departing from the scope of this disclosure. In different embodiments, computing system 1200 may take the form of a desktop computer, laptop computer, tablet computer, home entertainment computer, network computing device, mobile computing device, mobile communication device, gaming device, etc.

Computing system 1200 includes a computing device 1202 that includes a logic subsystem 1210 and a data-holding subsystem 1212. Computing system 1200 may optionally include a user input device 1220, graphical display device 1222, audio speaker 1224, and/or other components not shown in FIG. 12.

Logic subsystem 1210 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 1212 may include one or more physical, non-transitory, devices configured to hold data 1216 and/or instructions 1214 executable by the logic subsystem to implement the herein described methods and processes. When such methods and processes are implemented, the state of data-holding subsystem 1212 may be transformed (e.g., to hold different data).

Data-holding subsystem 1212 may include removable media and/or built-in devices. Data-holding subsystem 1212 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 1212 may include devices with one or more of the following characteristics: volatile, nonvolatile, dynamic, static, read/write, read-only, random access, sequential access, location addressable, file addressable, and content addressable. In some embodiments, logic subsystem 1210 and data-holding subsystem 1212 may be integrated into one or more common devices, such as an application specific integrated circuit or a system on a chip.

It is to be appreciated that data-holding subsystem 1212 includes one or more physical, non-transitory devices. In contrast, in some embodiments, aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

Data 1216 of data-holding subsystem 1212 may include one or more media content items. Media content items may include time-based media content items, such as video content items and/or audio content items, for example. Data 1216 may further include other types of media content items (e.g., non-time based). For example, data 1216 may include one or more linear media content items. As one example, a linear media content item may refer to a collection of one or more media content items having a defined order. It will be appreciated that the methods and processes described herein with respect to time-based media content items may be applied to linear media content items to enable a user to move or navigate within a collection of one or more media content items having a defined order.

When included, graphical display device 1222 may be used to present a visual representation of data held by data-holding subsystem 1212. As the herein described methods and processes change the data held by the data-holding subsystem, and thus transform the state of the data-holding subsystem, the state of graphical display device 1222 may likewise be transformed to visually represent changes in the underlying data. Graphical display device 1222 may include one or more display devices utilizing virtually any type of technology. Such display devices may be combined with logic subsystem 1210 and/or data-holding subsystem 1212 of computing device 1202 in a shared enclosure, or such display devices may be peripheral display devices.

User input device 1220 may include one or more keyboards, mice, game controllers, optical sensor systems, microphones, and/or touch screens, for example. An optical sensor system may include one or more optical sensors such as a visible light sensor, RGB sensor, infrared sensor, depth camera, and/or other suitable optical sensor or combination thereof. Graphical display device 1222 may include or take the form of a television, display monitor, projector, or touch-sensitive graphical display configured to receive user input.

One or more of these input devices and/or output devices may be combined into one or more common devices. As one example, graphical display device 1222 and audio speaker 1224 may be combined into a common audio-visual system 1225.

Computing device 1202 includes an input/output (I/O) device interface 1218 to communicate with one or more input devices and/or output devices such as user input device 1220, graphical display device 1222, and audio speaker 1224. I/O device interface 1218 may support or otherwise facilitate wired and/or wireless communications between computing device 1202, and one or more of these input devices and/or output devices of computing system 1200.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A data-holding subsystem holding instructions executable by a logic subsystem to:
output a graphical user interface for presentation via a graphical display device, the graphical user interface including:
visual aspects of a time-based media content item having a playback axis; and
a seek bar having a position along the playback axis, the position of the seek bar along the playback axis indicating a current playback position of the time-based media content item, the seek bar extending perpendicular to the playback axis over the visual aspects of the time-based media content item;
receive a drag command representing a user input directed at the seek bar, the drag command characterized by a drag path; and
move the current playback position of the time-based media content item based on the drag path.

2. The data-holding subsystem of claim 1, where the visual aspects of the time-based media content item are bound by a first edge parallel to the playback axis and a second edge parallel to the playback axis, and where the seek bar extends from the first edge to the second edge over the visual aspects of the time-based media content item.

3. The data-holding subsystem of claim 1, the instructions further executable to:
move the current playback position of the time-based media content item in a forward direction if the drag path has a vector component in a first coordinate direction parallel to the playback axis; and
move the current playback position of the time-based media content item in a reverse direction if the drag path has a vector component in a second coordinate direction opposite the first coordinate direction and parallel to the playback axis.

4. The data-holding subsystem of claim 3, the instructions further executable to:
move the current playback position of the time-based media content item in the forward direction or in the reverse direction by an amount that is based on a distance measured along the playback axis from an initial position to a remote position of the drag path.

5. The data-holding subsystem of claim 4, wherein the amount that the current playback position is moved in the forward or in the reverse direction is further based on a combination of a scaling factor and the distance measured along the playback axis from the initial position to the remote position of the drag path;
the instructions further executable to vary the scaling factor based on a distance measured along an axis perpendicular to the playback axis from the initial position to the remote position of the drag path.

6. The data-holding subsystem of claim 5, the instructions further executable to:
vary the scaling factor by decreasing the scaling factor as the distance measured along the axis perpendicular to the playback axis from the initial position to the remote position of the drag path increases.

7. The data-holding subsystem of claim 6, the instructions further executable to:
decrease the scaling factor by a step-wise function as the distance measured along the axis perpendicular to the playback axis from the initial position to the remote position of the drag path increases.

8. The data-holding subsystem of claim 1, the visual aspects of the time-based media content item including video content, the instructions further executable to:
vary the current playback position of the video content responsive to the dragging command.

9. The data-holding subsystem of claim 1, the instructions further executable to:
output audio information representing audio aspects of the time-based media content item; and
vary the current playback position of the audio aspects responsive to the dragging command.

10. The data-holding subsystem of claim 1, the seek bar of the graphical user interface further including a selector, the selector corresponding to an initial position of the drag path and a centerline position of the seek bar.

11. The data-holding subsystem of claim 1, the seek bar having a vertical orientation relative to a display orientation of the visual aspects of the time-based media content item.

12. The data-holding subsystem of claim 1, the instructions further executable to:
discontinue presentation of the seek bar if no user input is directed at the graphical user interface for a threshold period of time; and
initiate presentation of the seek bar if another user input is directed at the graphical user interface after presentation of the seek bar is discontinued.

13. The data-holding subsystem of claim 1, where the graphical user interface further includes one or more transport control buttons overlaying the visual aspects of the time-based media content item, the instructions further executable to:
discontinue presentation of the seek bar if user input is directed at the one or more transport control buttons.

14. The data-holding subsystem of claim 1, wherein the seek bar extends beyond an edge of the visual aspects of the time-based media content item.

15. A method of presenting time-based media content items with a computing device, comprising:
outputting a graphical user interface for presentation via a graphical display device, the graphical user interface including:
visual aspects of a time-based media content item having a playback axis; and
a seek bar having a position along the playback axis, the position of the seek bar along the playback axis indicating a current playback position of the time-based media content item, the seek bar extending perpendicular to the playback axis over the visual aspects of the time-based media content item, the time-based media content item bound by a first edge parallel to the playback axis and a second edge parallel to the playback axis, the seek bar extending from the first edge to the second edge over the visual aspects of the time-based media content item;
receiving a drag command representing a user input directed at the seek bar, the drag command characterized by a two-dimensional drag path; and
moving the current playback position of the time-based media content item based on the two-dimensional drag path.

16. The method of claim 15, further comprising:
moving the current playback position of the time-based media content item in a forward direction if the two-dimensional drag path has a vector component in a first coordinate direction parallel to the playback axis; and
moving the current playback position of the time-based media content item in a reverse direction if the two-dimensional drag path has a vector component in a second coordinate direction opposite the first coordinate direction and parallel to the playback axis;
wherein the amount that the current playback position is moved is based on a distance measured along the playback axis from an initial position to an remote position of the drag path.

17. The method of claim 16, wherein the amount that the current playback position is moved in the forward or in the reverse direction is further based on a combination of a scaling factor and the distance measured along the playback axis from the initial position to the remote position of the drag path; and
wherein the scaling factor is based on a distance measured along an axis perpendicular to the playback axis from the initial position to the remote position of the two-dimensional drag path.

18. The method of claim 17, wherein the scaling factor decreases as the distance measured along the axis perpendicular to the playback axis from the initial position to the remote position of the drag path increases.

19. The method of claim 15, further comprising:
discontinuing presentation of the seek bar if no user input is directed at the graphical user interface for a threshold period of time;
initiating presentation of the seek bar if another user input is directed at the graphical user interface after presentation of the seek bar is discontinued;
where the graphical user interface further includes one or more transport control buttons overlaying the visual aspects of the time-based media content item; and
wherein the method further comprises discontinuing presentation of the seek bar if user input is directed at the one or more transport control buttons.

20. A computing device, comprising:
a touch-sensitive graphical display to present a graphical user interface and receive user input;
a logic subsystem;
a data-holding subsystem holding instructions executable by the logic subsystem to:
output the graphical user interface for presentation via the touch-sensitive graphical display, the graphical user interface including:
visual aspects of a time-based media content item having a playback axis; and
a seek bar having a position along the playback axis, the position of the seek bar along the playback axis indicating a current playback position of the time-based media content item, the seek bar extending perpendicular to the playback axis over the visual aspects of the time-based media content item, the time-based media content item bound by a first edge parallel to the playback axis and a second edge parallel to the playback axis, the seek bar extending from the first edge to the second edge over the visual aspects of the time-based media content item;
receive a drag command representing a user input directed at the seek bar, the drag command characterized by a drag path; and
move the current playback position of the time-based media content item responsive to the drag command, the amount that the current playback position is moved in a forward or in a reverse direction increasing as a distance measured along the playback axis from an initial position to a remote position of the drag path increases, and decreasing as a distance measured along an axis perpendicular to the playback axis from the initial position to the remote position of the drag path increases.
